(19) United States
(12) Patent Application Publication
(10) Pub. No.: US 2026/0270676 A1
(43) Pub. Date: Sep. 10, 2026

(54) METHOD OF DATA-DRIVEN MODEL SIGNALING FOR MULTI-USIM

(71) Applicant: Continental Automotive Technologies GmbH, Hannover (DE)

(72) Inventors: Hojin KIM, Regensburg (DE); Rikin SHAH, Langen, Hessen (DE); David GONZALEZ GONZALEZ, Egelsbach, Hessen (DE); Reuben GEORGE STEPHEN, Singapore (SG)

(73) Assignee: Continental Automotive Technologies GmbH, Hannover (DE)

(21) Appl. No.: 19/167,006

(22) PCT Filed: Apr. 23, 2024
(86) PCT No.: PCT/EP2024/061093

§ 371 Date: Sep. 19, 2025

(30) Foreign Application Priority Data
Apr. 24, 2023 (DE) 10 2023 203 724.6

(51) Int. Cl. H04W 8/18

(52) U.S. Cl. CPC H04W 8/186

(57) ABSTRACT

The present disclosure describes methods of data-driven AI/ML model signaling for multi-USIM in wireless mobile communication system including base station (e.g., gNB) and mobile station (e.g., UE). Multiple model operations is performed sequentially or in parallel across multiple USIMs with separate radio links based on cooperative mechanism.

### CROSS REFERENCE TO RELATED APPLICATIONS

This application is the U.S. National Phase Application of PCT International Application No. PCT/EP2024/061093, filed Apr. 23, 2024, which claims priority to German Patent Application No. 10 2023 203 724.6, filed Apr. 24, 2023, the contents of such applications being incorporated by reference herein.

### TECHNICAL FIELD

The present disclosure relates to AI/ML based model signaling, where techniques for pre-configuring and signaling the specific information about collaborative model operation across multi-USIMs with separate radio links are presented.

### BACKGROUND

In 3GPP (3rd Generation Partnership Project), one of the selected study items as the approved Release 18 package is AI/ML (artificial intelligence/machine learning) as described in the related document (RP-213599) addressed in 3GPP TSG RAN (Technical Specification Group Radio Access Network) meeting #94e. The official title of AI/ML study item is “Study on AI/ML for NR Air Interface”, incorporated herein by reference, and currently RAN WG1 and WG2 are actively working on specification. The goal of this study item is to identify a common AI/ML framework and areas of obtaining gains using AI/ML based techniques with use cases. According to 3GPP, the main objective of this study item is to study AI/ML framework for air-interface with target use cases by considering performance, complexity, and potential specification impact. In particular, AI/ML model, terminology and description to identify common and specific characteristics for framework will be one of key work scope. Regarding AI/ML framework, various aspects are under consideration for investigation and one of key items is about lifecycle management of AI/ML model where multiple stages are included as mandatory for model training, model deployment, model inference, model monitoring, model updating etc. Earlier, in 3GPP TR 37.817 for Release 17, titled as Study on enhancement for Data Collection for NR and EN-DC, incorporated herein by reference, UE mobility was also considered as one of AI/ML use cases and one of scenarios for model training/inference is that both functions are located within RAN node. Followingly, in Release 18 the new work item of “Artificial Intelligence (AI)/Machine Learning (ML) for NG-RAN” was initiated to specify data collection enhancements and signaling support within existing NG-RAN interfaces and architecture.

For the above active standardization works, currently there is no specification defined for signaling methods or network (e.g., gNB)/mobile station (e.g., UE) behaviors about supporting AI/ML model operation when UE has multiple USIMs (universal subscriber identity module). With a single USIM, multiple ML operations are limited for parallel processing such as inferencing and online training and with two or more multi-USIMs (MUSIM), dedicated ML operations with separate radio links are possible. When model performance is degraded over single-USIM based radio link, model adaptation such as model switching/re-training/fallback is needed. As a result, latency and/or signaling overhead would occur. Therefore, it is needed to specify MUSIM-based signaling/procedure for model operation.

U.S. Pat. No. 11,463,865B1, incorporated herein by reference, shows techniques that enable a wireless carrier network to provide a subscriber of a competitor wireless carrier network with an opportunity to experience a trial use of wireless telecommunication services provided by the wireless carrier network.

US2022295343A1, incorporated herein by reference, describes systems and processes for high-throughput wireless communications where UE is configured to receive data indicative of link metrics for each available communications link over which the UE is configured to communicate and UE is configured to determine whether a network over which the UE is communicating is congested.

US2020312301A1, incorporated herein by reference, explains about systems and techniques for model adaptation where a set of adaptation training data and a set of parameters are received and a set of adaptation parameters may be determined using the set of adaptation training data.

US2021133588A1, incorporated herein by reference, shows the machine learning model for classification can be adapted to changes in features of input data to provide better classification performance.

U.S. Pat. No. 10,990,850B1, incorporated herein by reference, describes that the model adaptation controller is used to retrain the deployed ML model using samples with ground truth values generated by the different ML model and this retraining process may be performed iteratively to automatically improve and adapt the ML model running at the edge device.

WO2022099425A1, incorporated herein by reference, describes the method of adjusting the current set of configuration parameters to minimize a loss function for the machine learning model for the plurality of mixed data elements where it results in adapted machine learning model with the improved performance at inference on new target samples.

Cooperative ML is proposed to support sequential/parallel model operations across multiple USIMs with separate radio links between gNB and UE.

The Benefits are latency reduction, signaling overhead reduction per USIM through joint ML operation.

The first aspect is as method of data-driven model signaling for multi-USIM with cooperative operation of AI/ML model, comprising the steps, enabling/disabling cooperative ML (CM) operation through multi-USIM (MUSIM), determining different CM types (e.g., sequential CM and parallel CM) according to UE capability of modem/RF chains to support DSDS/DSDA, performing different CM operation modes that are assigned to each USIMs based on mapping relationship between CM mode and USIMs, determining primary and supplementary CM operation modes for each USIMs.

In some embodiments of the method according to the first aspect, the method is characterized by, that CM modes are defined and pre-configured for a set of mode categories where based on lifecycle management operation of ML, mode category can be either baseline mode or enhanced mode and ML operations are then indexed with different CM mode for configuration.

In some embodiments of the method according to the first aspect, the method is characterized by, that multiple radio links can be cooperative to process model operation between UE and different gNBs across MUSIM where different model operation modes can be configured.

In some embodiments of the method according to the first aspect, the method is characterized by, that CM operation is enabled or disabled depending on MUSIM configuration where the indication message to enable/disable MUSIM-based CM is transmitted through L1/L2 signaling.

In some embodiments of the method according to the first aspect, the method is characterized by, that either sequential or parallel CM is determined according to UE Tx/Rx capability of modem/RF chains to support DSDS/DSDA, comprising, performing sequential CM where single CM mode is operated at a time with any activated USIM as connected mode and any associated CM mode in combination can be operated sequentially through the same USIM or different USIM, performing parallel CM where two or more CM modes are operated in parallel as MUSIMs are activated simultaneously as connected mode so that the pre-configured combination of CM modes with MUSIMs can then be performed.

In some embodiments of the method according to the first aspect, the method is characterized by, that primary and supplementary CM is performed for MUSIM where CM operation modes are assigned to each USIMs wherein mapping of CM mode to MUSIMs is based on different criteria (e.g., ML support configuration, radio link conditions, etc.), comprising, assigning primary CM mode USIM1 (for mandatory ML operation, e.g., model inferencing) and assigning supplementary CM mode is assigned to USIM2 (for mandatory/optional ML operation, e.g., model training, pre-configuring supplementary CM mode in association with primary CM mode for CM mode combinations wherein index value of CM modes is then indicated through DCI and/or MAC CE and/or RRC signaling.

In some embodiments of the method according to the first aspect, the method is characterized by, that priority level of CM modes is set for the preferred CM mode combination, comprising determining CM modes with MUSIM, indicating priority level for each CM modes with MUSIM, prioritizing primary ML operation(s) for processing over one of dedicated USIM link where priority level of CM modes can be dynamically switched or updated, pre-configuring number of priority levels that can be more than two and each prioritized CM modes are associated with the assigned USIMs.

In some embodiments of the method according to the first aspect, the method is characterized by, that the prioritized CM mode is determined based on priority of CM modes when any used radio link(s) becomes unavailable for other service, comprising, pre-configuring higher prioritized CM mode (through primary link) and lower prioritized CM mode (through non-primary link), setting CM mode priority level of each MUSIM links for switching activity.

In some embodiments of the method according to the first aspect, the method is characterized by, that DSDA/DSDS-based cooperative ML is configured between gNB and UE, comprising generating candidate combinations of CM mode with USIM1 and USIM2 for model operation, receiving CM mode selection from non-primary link, performing final CM mode combination.

In some embodiments of the method according to the first aspect, the method is characterized by, that CM operation is activated with triggering event where CM with MUSIM is activated from non-cooperative ML using single-USIM with the list of triggering events, e.g., traffic load to activate CM and the request of CM can be decided by network side or also by UE side for implementation-specific use cases.

In some embodiments of the method according to the first aspect, the method is characterized by, that CM operation is activated with model split where ML model for operation between network and UE is split and the splitted models are processed through each MUSIMs. In a similar way, dataset for model training/inferencing/monitoring can be also split into multiple dataset groups to be processed through each USIM links.

According to a second aspect, the present disclosure relates to an apparatus for a data-driven model signaling for multi-USIM with cooperative operation of AI/ML model cooperative, the apparatus comprising a wireless transceiver, a processor coupled with a memory in which computer program instructions are stored, said instructions being configured to implement steps of the first aspect.

According to a third aspect, the present disclosure relates to an apparatus for a data-driven model signaling for multi-USIM with cooperative operation of AI/ML model cooperatively by a gNB, the apparatus comprising a wireless transceiver, a processor coupled with a memory in which computer program instructions are stored, said instructions being configured to implement steps of the first aspect.

According to a fourth aspect, the present disclosure relates to a user Equipment comprising an apparatus according to any one of the embodiments of the second aspect.

According to a fifth aspect, the present disclosure relates to a baste station comprising an apparatus according to any one of the embodiments of the third aspect.

According to a sixth aspect, the present disclosure relates to a wireless communication system, wherein the gNB comprises a processor coupled with a memory in which computer program instructions are stored, said instructions being configured to implement steps of the first aspect, wherein the user equipment (UE) comprises a processor coupled with a memory in which computer program instructions are stored, said instructions being configured to implement steps of the first aspect.

According to a fifth aspect, the present disclosure relates to a wireless communication system comprising at least one base station according to any one of the embodiments of the present disclosure and at least one user equipment according to carry out a method according to any one of the embodiments of the first aspect.

According to a sixth aspect, the present disclosure relates to a computer program product comprising instructions which, when executed by at least one processor, configure said at least one processor to carry out a method according to the first aspect said at least one processor to carry out a method for exchanging data according to any one of the embodiments of the present disclosure. The computer program product can use any programming language, and can be in the form of source code, object code, or in any intermediate form between source code and object code, such as in a partially compiled form, or in any other desirable form.

According to a seventh aspect, the present disclosure relates to a computer-readable storage medium comprising instructions which, when executed by at least one processor, configure said at least one processor to carry out a method according to any one of the embodiments of the present disclosure.

### BRIEF DESCRIPTION OF THE DRAWINGS

FIG. 1 is an exemplary table of cooperative ML modes.

FIG. 2 is an exemplary table of multi-USIM based cooperative ML modes.

FIG. 3 is a flow chart of enabling/disabling cooperative ML for multi-USIM.

FIG. 4 is a flow chart of enabling sequential/parallel cooperative ML for multi-USIM.

FIG. 5 is a flow chart of primary and supplementary cooperative ML for multi-USIM.

FIG. 6 is an exemplary table of setting priority level of cooperative ML modes.

FIG. 7 is a signaling flow of priority level of cooperative ML mode.

FIG. 8 is a signaling flow of cooperative ML for inter-PLMN.

FIG. 9 is a signaling flow of cooperative ML for intra-PLMN.

FIG. 10 is a signaling flow of activating cooperative ML with triggering event.

FIG. 11 is a signaling flow of activating cooperative ML with model split.

### DETAILED DESCRIPTION

The following explanation will provide the detailed description of the mechanism about data-driven AI/ML model signaling for multi-USIM (MUSIM) in wireless mobile communication system including base station (e.g., gNB) and mobile station (e.g., UE) wherein multiple model operations is performed sequentially or in parallel across multiple USIMs with separate radio links. AI/ML based techniques are currently applied to many different applications and 3GPP also started to work on its technical investigation to apply to multiple use cases based on the observed potential gains. AI/ML lifecycle can be split into several stages such as data collection/pre-processing, model training, model testing/validation, model deployment/update, model monitoring, model switching/selection etc., where each stage is equally important to achieve target performance with any specific model(s).

In applying AI/ML model for any use case or application, one of the challenging issues is to manage the lifecycle of AI/ML model. It is mainly because the data/model drift occurs during model deployment/inference and it results in performance degradation of AI/ML model. Fundamentally, the dataset statistical changes occur after model is deployed and model inference capability is also impacted with unseen data as input.

In a similar aspect, the statistical property of dataset and the relationship between input and output for the trained model can be changed with drift occurrence. Then model adaptation is required to support operations such as model switching, re-training, fallback, etc. When AI/ML model enabled wireless communication network is deployed, it is then important to consider how to handle adaptation of AI/ML model under operations such as model training, inference, monitoring, updating, etc. For MUSIM, there are different types such as DSDS (Dual SIM-Dual Standby) and DSDA (Dual-SIM-Dual Active). For DSDS, UE is limited to connecting to one network at a time and only one SIM for connection at any given time. For example, when the UE is using one SIM for connection, e.g., for a voice call, the other SIM will be idle. For DSDA, UE may connect to multiple networks, capable of using two SIMs and two radios so as to maintain two active sets of data communication simultaneously. When there is a DSDA configuration, the application to network mapping may be accomplished concurrently. For example, a voice call using one SIM and data communication (e.g., Internet browsing) on the second SIM.

Based on those types of MUSIM such as DSDS and DSDA, techniques for pre-configuring and signaling the specific information about collaborative model operation with separate radio links are described. Firstly, to enable cooperative ML (CM) operation through MUSIM, the indication message to enable MUSIM-based CM is transmitted and L1/L2 signaling is used for transmission. For example, a single bit can be used to indicate that bit 0 is to enable CM and bit 1 is to disable CM. CM type as either sequential or parallel CM is also determined according to UE transmission (Tx) and reception (Rx) capability of modem/RF chains to support DSDS/DSDA. For example, if DSDS is configured, the sequential CM is used and if DSDA is configured, the parallel CM is used. For sequential CM, single CM mode is operated at a time with any activated USIM as connected mode and any associated CM mode in combination can be operated sequentially through the same USIM or different USIM. For parallel CM, two or more CM modes are operated in parallel as MUSIMs are activated simultaneously as connected mode. Therefore, the pre-configured combination of CM modes with MUSIMs can then be performed. CM operation modes are assigned to each USIMs wherein mapping of CM mode to MUSIM is based on different criteria such as ML support configuration, radio link conditions, etc. For example, primary CM mode is assigned to USIM1 (for mandatory ML operation, e.g., model inferencing) and supplementary CM mode is assigned to USIM2 (for mandatory/optional ML operation, e.g., model training). If there are more than two USIMs, more than one primary and/or supplementary CM modes can be assigned to those USIMs. Depending on the activated CM type and primary CM mode, supplementary CM mode can be pre-configured in association with primary CM mode so as to reduce model adaptation latency and/or to balance signaling overhead across MUSIM radio links. For example, CM mode combinations for MUSIM can be pre-configured for primary and supplementary CM modes in advance wherein index value of CM modes is then indicated (through DCI, MAC CE, or RRC signaling).

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS.

An example of a wireless device suitable for implementing any method, discussed in the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like. The UE may also be an Internet of Things (IoT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

The description of elements in each figure may refer to elements of proceeding figures. Like numbers refer to like elements in all figures, including alternate embodiments of like elements

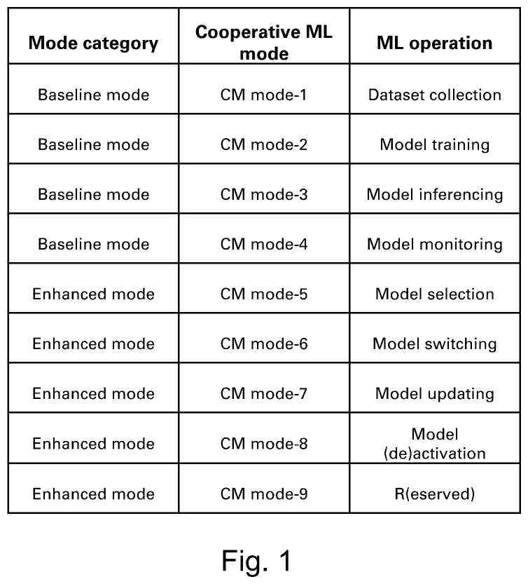

FIG. 1 shows an exemplary table of CM modes. Based on using MUSIM in UE for ML operation, CM modes are defined and pre-configured for a set of mode categories. Based on lifecycle management operation of ML, mode category can be either baseline mode or enhanced mode. ML operations are then indexed with different CM mode for configuration. When UE has different number of USIMs, combinations of multiple CM modes are configured.

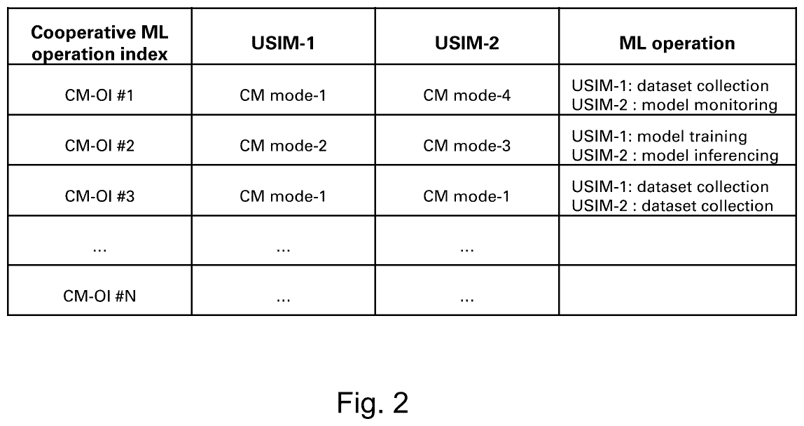

FIG. 2 shows an exemplary table of MUSIM based CM modes. MUSIM can provide multiple radio links between UE and different gNBs. AI/ML model operation can be extended to multiple radio links with separate radio resources simultaneously in connection with separate gNBs/networks. Depending on different model operation modes, multiple radio links can be cooperative to process model operation between UE and different gNBs across MUSIM. With CM operation, target benefits include signaling overhead balancing across radio links and latency reduction by utilizing multiple link based simultaneous model operation, etc.

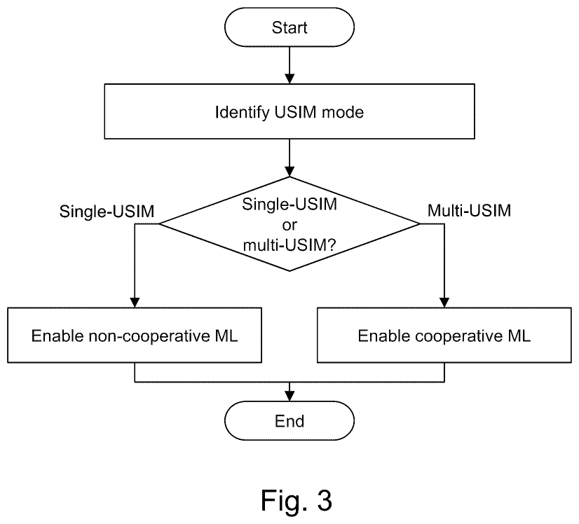

FIG. 3 shows a flow chart of enabling/disabling CM for MUSIM. This shows whether or not cooperative ML is enabled depending on USIM configuration. For example, when single-USIM is used, CM is not operated. And MUSIM enables CM, instead. The indication message to enable MUSIM-based CM is transmitted and L1/L2 signaling is used for transmission. For example, a single bit can be used to indicate that bit 0 is to enable CM and bit 1 is to disable CM.

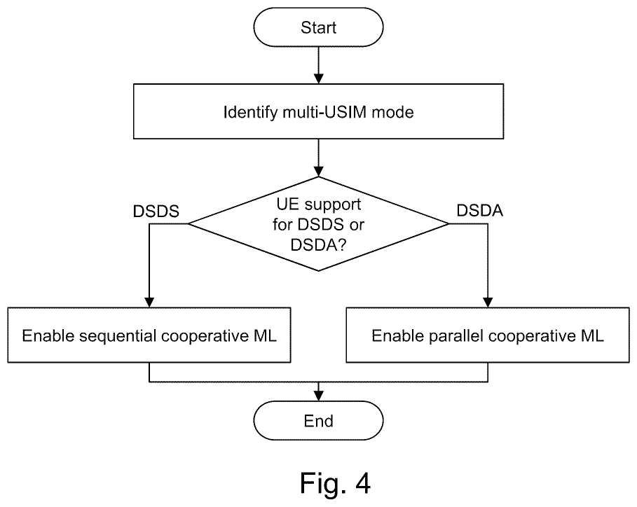

FIG. 4 shows a flow chart of enabling sequential/parallel CM for MUSIM. Cooperative ML type as either sequential or parallel CM is determined according to UE Tx/Rx capability of modem/RF chains to support DSDS/DSDA. For example, DSDS is used for sequential CM and DSDA is used for parallel CM. For sequential CM, single CM mode is operated at a time with any activated USIM as connected mode and any associated CM mode in combination can be operated sequentially through the same USIM or different USIM. For parallel CM, two or more CM modes are operated in parallel as MUSIMs are activated simultaneously as connected mode. Therefore, the pre-configured combination of CM modes with MUSIMs can then be performed.

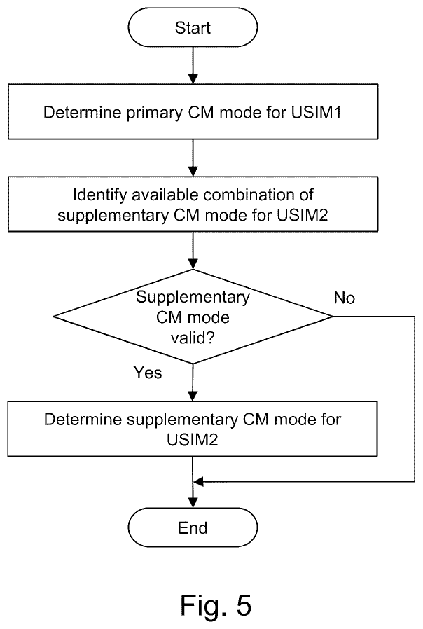

FIG. 5 shows a flow chart of primary and supplementary CM for MUSIM. CM operation modes are assigned to each USIMs wherein mapping of CM mode to MUSIMs is based on different criteria such as ML support configuration, radio link conditions, etc. For example, primary CM mode is assigned to USIM1 (for mandatory ML operation, e.g., model inferencing) and supplementary CM mode is assigned to USIM2 (for mandatory/optional ML operation, e.g., model training). Depending on the activated CM type and primary CM mode, supplementary CM mode can be pre-configured in association with primary CM mode so as to reduce model adaptation latency and/or to balance signaling overhead across MUSIM radio links. For example, CM mode combinations for MUSIM can be pre-configured for primary and supplementary CM modes in advance wherein index value of CM modes is then indicated (through DCI, MAC CE, or RRC signaling).

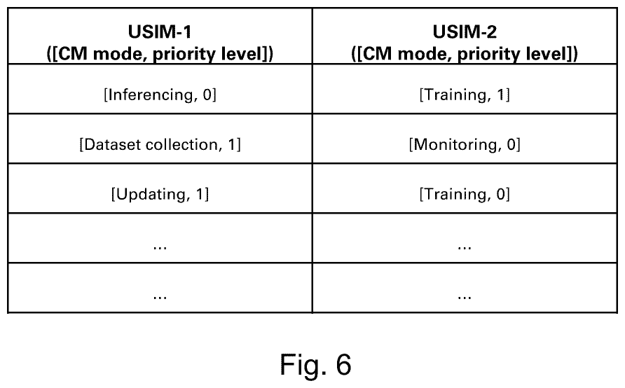

FIG. 6 shows an exemplary table of setting priority level of CM modes. Based on two-sided or UE-sided model setup, ML operation is configured for MUSIM device using the preferred CM mode combination. As step #1, with multiple radio links for each MUSIMs, CM modes are determined. And in step #2, for each CM modes, priority level is indicated for each mode so that primary ML operation(s) can be prioritized for processing over one of dedicated USIM link. For example, bit 0 indicates high priority and bit 1 indicates low priority if 1-bit is used. Priority level of CM modes can be dynamically switched or updated. Number of priority levels can be more than two and each prioritized CM modes are associated with the assigned USIMs.

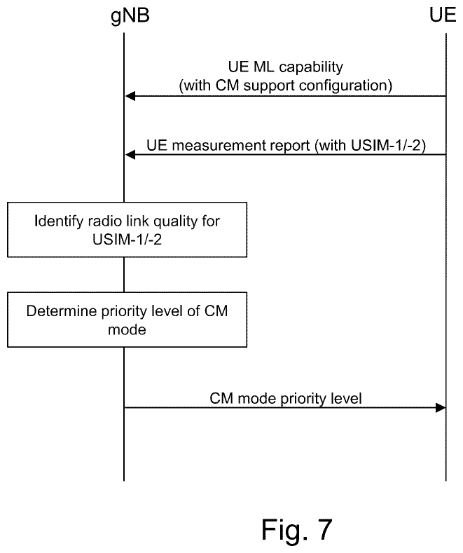

FIG. 7 shows a signaling flow of priority level of CM mode. When two radio links are used for CM operation, one of the links might need to switch to other ML operation with a separate dedicated model activation (e.g., ML operation interruption). In this case, “priority level of CM mode” is used to determine the prioritized CM mode when one of two links becomes unavailable for other service. Therefore, CM mode combination for two USIMs will have the pre-configured priority level in advance such as higher prioritized CM mode (through primary link) and lower prioritized CM mode (through non-primary link). CM mode priority level is also used for UE MUSIM behavior for switching activity. If there are more than two USIMs, priority levels of CM modes for each USIMs can be configured.

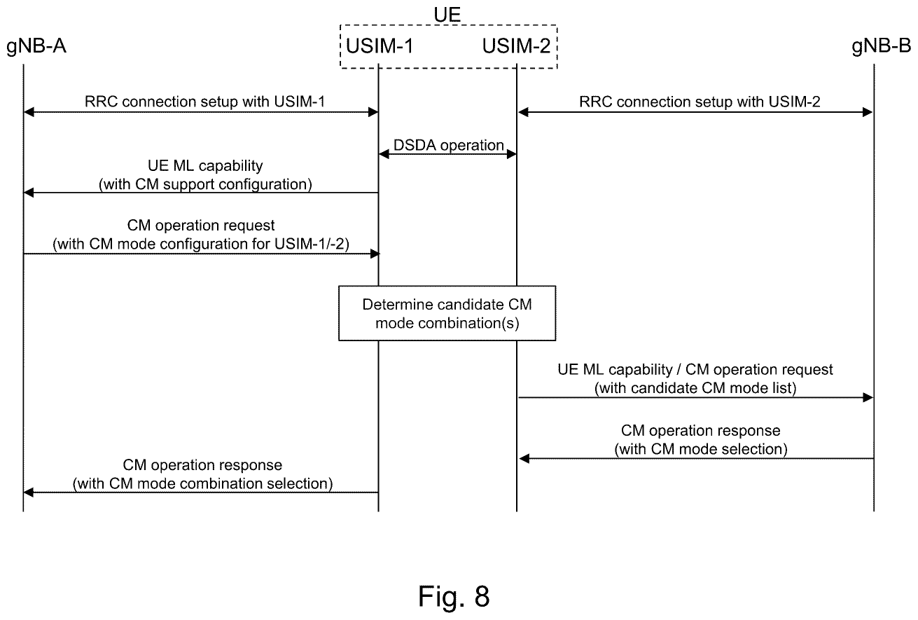

FIG. 8 shows a signaling flow of CM for inter-PLMN (Public Land Mobile Network). In this figure, it is assumed that two USIMs belong to the separate PLMNs (e.g., inter-PLMN). DSDA-based cooperative ML is configured between gNB and UE. Between primary link gNB and UE, candidate combinations of CM mode with USIM1 and USIM2 are generated for model operation. After receiving CM mode selection from non-primary link gNB, final CM mode combination is confirmed. For DSDS scenario, the similar procedure can be applied but radio link need to be used in time-multiplexed manner.

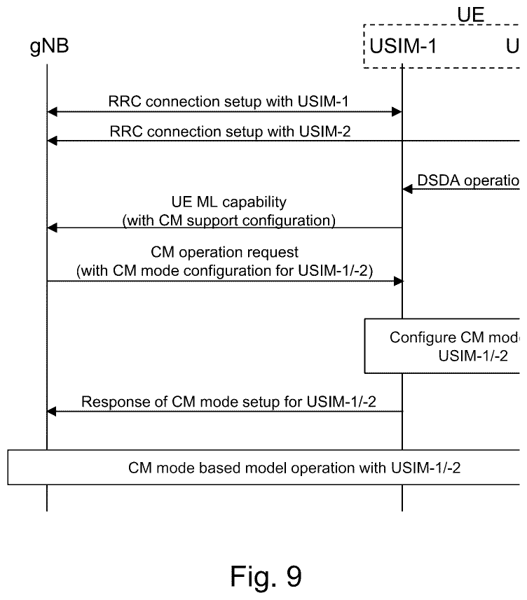

FIG. 9 shows a signaling flow of CM for intra-PLMN. In this figure, two USIMs belong to the same PLMN (e.g., intra-PLMN). DSDA-based cooperative ML is configured between gNB and UE. Based on the reported CM support capability of UE, CM mode combination with USIM1 and USIM2 is determined for model operation. After the confirmed CM operation setup, model operation is started. In this scenario, different RAN nodes supporting UE with MUSIM can communicate with each other through X2 interface for CM operation related signaling.

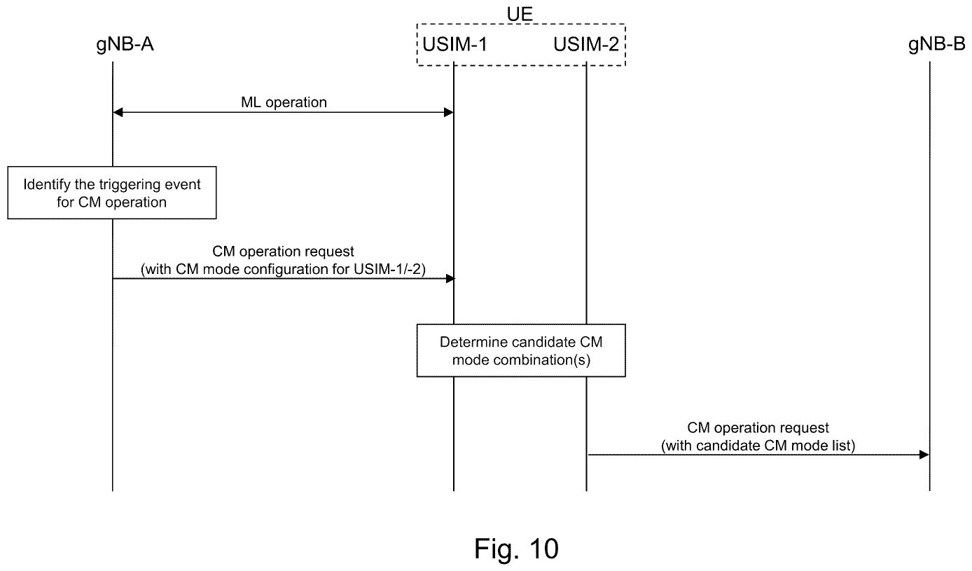

FIG. 10 shows a signaling flow of activating CM with triggering event. CM with MUSIM can be activated from non-cooperative ML using single-USIM. The list of triggering events (e.g., traffic load) to activate cooperative ML can be pre-configured so that CM mode(s) can be determined across each USIMs. The request of CM can be decided by network side or also by UE side for implementation-specific use cases.

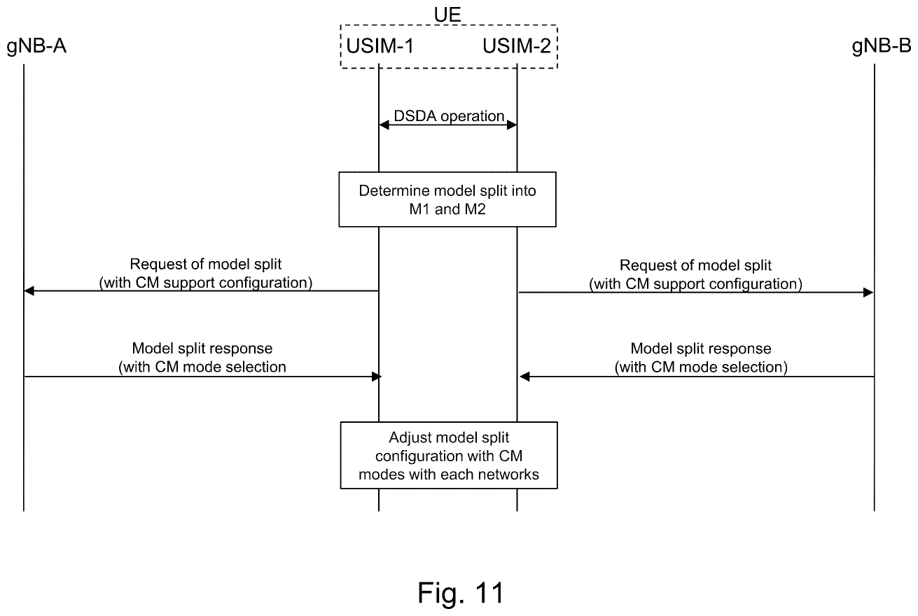

FIG. 11 shows a signaling flow of activating CM with model split. To improve signaling overhead imbalance and ML processing latency, ML model for operation between network and UE can be split into M1 and M2 where M1 is ML model to be processed through USIM1 and M2 is ML model to be processed through USIM2. Dataset for model training/inferencing/monitoring can be also split into multiple dataset groups to be processed through each USIM links.

In this described method, key advantages include latency reduction and signaling overhead imbalance reduction through joint ML operation across different number of MUSIM based radio links.

This application is intended to provide fundamental mechanisms of interworking and data information flow in radio access network collaboration for AI/ML support, especially in multi-USIM based ML operation aspect.

Based on the proposed invention, gNB-UE behaviors for supporting AI/ML operation for wireless communication with joint ML operation can be greatly improved with the potential scenarios.

1. A method of data-driven model signaling for multi-USIM with cooperative operation of AI/ML model, comprising:
Enabling/disabling cooperative ML (CM) operation through multi-USIM (MUSIM);
Determining different CM types (e.g., sequential CM and parallel CM) according to UE capability of modem/RF chains to support DSDS/DSDA;
Performing different CM operation modes that are assigned to each USIMs based on mapping relationship between CM mode and USIMs;
Determining primary and supplementary CM operation modes for each USIMs

2. The method according to claim 1, wherein CM modes are defined and pre-configured for a set of mode categories where based on lifecycle management operation of ML, mode category can be either baseline mode or enhanced mode and ML operations are then indexed with different CM mode for configuration.

3. The method according to claim 2, wherein multiple radio links can be cooperative to process model operation between UE and different gNBs across MUSIM where different model operation modes can be configured.

4. The method according to claim 1, wherein CM operation is enabled or disabled depending on MUSIM configuration where the indication message to enable/disable MUSIM-based CM is transmitted through L1/L2 signaling.

5. The method according to claim 1, wherein either sequential or parallel CM is determined according to UE Tx/Rx capability of modem/RF chains to support DSDS/DSDA, comprising:
Performing sequential CM where single CM mode is operated at a time with any activated USIM as connected mode and any associated CM mode in combination can be operated sequentially through the same USIM or different USIM;
Performing parallel CM where two or more CM modes are operated in parallel as MUSIMs are activated simultaneously as connected mode so that the pre-configured combination of CM modes with MUSIMs can then be performed.

6. The method according to claim 1, wherein primary and supplementary CM is performed for MUSIM where CM operation modes are assigned to each USIMs wherein mapping of CM mode to MUSIMs is based on different criteria ML support configuration and/or radio link conditions comprising:
Assigning primary CM mode USIM1 (for mandatory ML operation, e.g., model inferencing); and
Assigning supplementary CM mode is assigned to USIM2 (for mandatory/optional ML operation, e.g., model training);
Pre-configuring supplementary CM mode in association with primary CM mode for CM mode combinations wherein index value of CM modes is then indicated through DCI and/or MAC CE and/or RRC signaling.

7. The method according to claim 6, wherein priority level of CM modes is set for the preferred CM mode combination, comprising:
Determining CM modes with MUSIM;
Indicating priority level for each CM modes with MUSIM;
Prioritizing primary ML operation(s) for processing over one of dedicated USIM link where priority level of CM modes can be dynamically switched or updated;
Pre-configuring number of priority levels that can be more than two and each prioritized CM modes are associated with the assigned USIMs.

8. The method according to claim 7, wherein the prioritized CM mode is determined based on priority of CM modes when any used radio link(s) becomes unavailable for other service, comprising:
Pre-configuring higher prioritized CM mode (through primary link) and lower prioritized CM mode (through non-primary link);
Setting CM mode priority level of each MUSIM links for switching activity.

9. The method according to claim 1, wherein DSDA/DSDS-based cooperative ML is configured between gNB and UE, comprising:
Generating candidate combinations of CM mode with USIM1 and USIM2 for model operation;
Receiving CM mode selection from non-primary link;
Performing final CM mode combination.

10. The method according to claim 1, wherein CM operation is activated with triggering event where CM with MUSIM is activated from non-cooperative ML using single-USIM with the list of triggering events (e.g., traffic load) to activate CM and the request of CM can be decided by network side or also by UE side for implementation-specific use cases.

11. The method according to claim 1, wherein CM operation is activated with model split where ML model for operation between network and UE is split and the splitted models are processed through each MUSIMs. In a similar way, dataset for model training/inferencing/monitoring can be also split into multiple dataset groups to be processed through each USIM links.

12. Apparatus for a data-driven model signaling for multi-USIM with cooperative operation of AI/ML model cooperative, the apparatus comprising a wireless transceiver, a processor coupled with a memory in which computer program instructions are stored, said instructions being configured to implement the method of claim 1.

13. Apparatus for a data-driven model signaling for multi-USIM with cooperative operation of AI/ML model cooperatively by a gNB, the apparatus comprising a wireless transceiver, a processor coupled with a memory in which computer program instructions are stored, said instructions being configured to implement the method of claim 1.

14. User Equipment comprising an apparatus according to claim 12.

15. A Base station comprising an apparatus according to claim 13.

16. A wireless communication system, comprising a gNB and a User Equipment (UE),
wherein the gNB comprises a processor coupled with a memory in which computer program instructions are stored,
wherein the user equipment (UE) comprises a processor coupled with a memory in which computer program instructions are stored,
wherein said computer program instructions in each of the gNb and the UE are configured to implement method of claim 1.
